(19) United States
(12) Patent Application Publication
(10) Pub. No.: US 2025/0245633 A1
(43) Pub. Date: Jul. 31, 2025

(54) Systems and Methods for Scanning and Recycling Objects

(71) Applicant: Oba Hardy, Los Angeles, CA (US)

(72) Inventor: Oba Hardy, Los Angeles, CA (US)

(21) Appl. No.: 19/036,805

(22) Filed: Jan. 24, 2025

Related U.S. Application Data
(60) Provisional application No. 63/625,826, filed on Jan. 26, 2024.

(51) Int. Cl. G06Q 10/30

(52) U.S. Cl. CPC G06Q 10/30

(57) ABSTRACT

In one aspect, a method may be configured to transmit a connection request from a user device to a receptacle and receive confirmation of a connection. The user device may receive an indication of one or more objects being received by the receptacle and scanned by one or more sensors on the receptacle. The user device may receive an identification of a weight and a redemption value of each of the one or more objects. The user device may determine data metrics associated with each of the one or more objects. One or more recommendations may be determined based on the data metrics and provided at the user device.

### PRIORITY

This application claims the benefit under 35 U.S.C. § 119 (c) of U.S. Provisional Patent Application No. 63/625,826, filed 26 Jan. 2024, which is incorporated herein by reference.

### TECHNICAL FIELD

This disclosure generally relates to databases and file management within network environments, and in particular relates to hardware and software for automated digital systems for processing the recycling of objects such as containers.

### BACKGROUND

A computing device may execute instructions that are grouped together as a computer program to perform one or more related actions. The instructions of a computer program may be executed to perform a vast variety of different functionality to end users. Computing devices may be communicatively coupled to each other over a network, which may include electrical or optical wiring, wireless radio-frequency transceivers, or other network infrastructure. The computing devices may communicate with each other over the network, using a variety of communication protocols such as, for example, Transmission Control Protocol/Internet Protocol (TCP/IP). Computing devices may be coupled through a wireless communications network such as, for example, long-term evolution (LTE), 5G new radio (NR), or other wireless communication infrastructure. Computing devices may communicate with each other to perform transactions between parties such as, for example, to exchange funds (e.g., currency) between accounts, or trade funds for goods and/or services.

Recycling programs (e.g., government programs or private programs) are initiatives that aim to reduce waste, conserve resources, and protect the environment by promoting the collection, processing, and reuse of various materials. Different government agencies at the federal, state, and local levels may offer different recycling programs for different types of waste, such as paper, plastic, metal, glass, electronics, batteries, food, and clothing. Some of these programs may also provide incentives or rewards for participating, such as grants, discounts, credits, or donations. Agencies may define a redemption value for recycled products (e.g., aluminum cans, glass bottles, etc.), and promote exchange of recyclable products for this redemption value. For example, a redemption value may come in the form of a monetary, cash value, or it may take the form of credits, including but not limited to, store credits, ride-share credits, and stadium and event credits.

### SUMMARY OF PARTICULAR EMBODIMENTS

In particular embodiments, a digital recycling platform may assist a user via a processing device that helps the user identify and organize potentially recyclable objects (e.g., a bottle, a container, a can, etc.). The processing device may include various sensors, such as an image processor for scanning objects. The processing device may determine, based on the identity of an object, an amount associated with the object. This amount may be referred to as a redemption value. The processing device may determine a total amount (e.g., a total redemption value) associated with a plurality of objects, based on the amount. For example, the computing device may add a plurality of redemption values of scanned objects. The processing device may signal to a remote system, when the user is ready to have these objects collected and provide a location to pick up these objects. The processing device may provide information to the remote system such as the total weight of collected objects, for the remote system to confirm a total redemption amount against a physical measurable quantity. The processing device may receive confirmation (e.g., from the remote system) that the objects have been collected. The processing device may perform signaling with the remote system to receive credits (e.g., monetary credits) according to the total redemption value of the collected objects. These credits may be electronically stored in an account of the user. The processing device may perform various operations that improve the efficiency and experience for collecting and redeeming recyclable objects.

In particular embodiments, a computing device may transmit, from a user device to a receptacle, a connection request. A user device may receive a connection confirmation from the receptacle. The user device may receive from the receptacle an indication of one or more objects being received by the receptacle and scanned by one or more sensors on the receptacle. The user device may receive from the receptacle an identification of a weight and a redemption value of each of the one or more objects. The user device may determine data metrics associated with each of the one or more objects and determine, based on the data metrics, one or more recommendations. The user device may provide the one or more recommendations.

Certain technical challenges exist for a user who may seek to gather various potentially recyclable objects (e.g., aluminum cans, plastic or glass bottles, etc.) and redeem the objects for a reward. One technical challenge may include finding a proper recycling center that will exchange the collected objects for cash or credits. The solution presented by the embodiments disclosed herein to address this challenge may be providing signaling for a remote service to pick up collected objects to facilitate the exchange of cash or credits for recycled goods. Another technical challenge may include keeping an accurate count of the quantity and redemption value all the recyclable objects. The solution presented by the embodiments disclosed herein to address this challenge may be automatically providing a running total of cash and/or credit value and weight value of how much a user has collected via a system of processors and sensors and providing flexibility for users to collaborate together to pool collected objects over a digital recycling platform.

Certain embodiments disclosed herein may provide one or more technical advantages. A technical advantage of the embodiments may include utilizing data metrics based on the recyclable objects to provide recommendations to a user. As an example and not by way of limitation, recommendations may include suggestions about improving a user's diet based on the processed recyclable objects, and discounts on commonly recycled objects observed as a trend over time, currently available in grocery stores. Another technical advantage of the embodiments may include a user's ability to instantly redeem a reward based off of their recycling session results. Certain embodiments disclosed herein may provide none, some, or all of the above technical advantages. One or more other technical advantages may be readily apparent to one skilled in the art in view of the figures, descriptions, and claims of the present disclosure.

Particular embodiment described herein relate to a method, performed by a computing device, including: transmitting, from a user device to a receptacle, a connection request; receiving, at the user device and from the receptacle, a connection confirmation; receiving, at the user device and from the receptacle, an indication of one or more objects being received by the receptacle and scanned by one or more sensors on the receptacle; receiving, at the user device and from the receptacle, an identification of a weight and a redemption value of each of the one or more objects; determining, at the user device, data metrics associated with each of the one or more objects; determining, based on the data metrics, one or more recommendations; providing, at the user device, the one or more recommendations.

Particular embodiment described herein relate to a method, wherein the one or more recommendations includes providing, at the user device, a recommendation to take a specified action.

Particular embodiment described herein relate to a method, wherein the specified action includes redeeming a reward.

Particular embodiment described herein relate to a method, further including: receiving, at the user device, a second indication for collaboration with a second user device, wherein the indication for collaboration includes a request for selecting an agreed upon account to hold the redemption value.

Particular embodiment described herein relate to a method, further including: transmitting, from the user device, a signal for a pickup request, wherein the signal for the pickup request includes a second indication that a pickup weight of the one or more objects matches the weight of the one or more objects indicated in the pickup request.

Particular embodiment described herein relate to a method, further including: receiving, an indication that the redemption value is configured to be redeemed for one or more of cash value or credits.

Particular embodiment described herein relate to a method, wherein the receptacle includes a liquid strainer level configured to drain liquids into a liquid collection tray.

Particular embodiment described herein relate to a method, wherein the one or more sensors include an image processor.

Particular embodiment described herein relate to a method, wherein the data metrics can be used to identify trends for the one or more object.

Particular embodiment described herein relate to a method, wherein the data metrics may be uploaded via a network to a social media platform.

Particular embodiment described herein relate to a system including: a memory; and a processing device operatively coupled to the memory, the processing device configured to: transmit, from a user device to a receptacle, a connection request; receive, at the user device and from the receptacle, a connection confirmation; receive, at the user device and from the receptacle, an indication of one or more objects being scanned using one or more sensors; receive, at the user device and from the receptacle, an identification of a weight and a redemption value of each of the one or more objects; determine, at the user device, data metrics associated with each of the one or more objects; determine, based on the data metrics, one or more recommendations; provide, at the user device, the one or more recommendations.

Particular embodiment described herein relate to a non-transitory computer-readable storage medium including instructions which, when executed, cause one or more processers to: transmit, from a user device to a receptacle, a connection request; receive, at the user device and from the receptacle, a connection confirmation; receive, at the user device and from the receptacle, an indication of one or more objects being scanned using one or more sensors; receive, at the user device and from the receptacle, an identification of a weight and a redemption value of each of the one or more objects; determine, at the user device, data metrics associated with each of the one or more objects; determine, based on the data metrics, one or more recommendations; provide, at the user device, the one or more recommendations.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a block diagram of an example computing device that may support collection and redemption of recyclable objects, in accordance with one or more embodiments.

FIG. 2 illustrates a routine that is performed by a mobile computing device for scanning and recycling objects, in accordance with one or more embodiments.

FIG. 3 illustrates a workflow which may performed by a system (e.g., one or more computing devices) for scanning and recycling objects, in accordance with one or more embodiments.

FIG. 4 illustrates an example of a digital recycling platform, in accordance with one or more embodiments.

FIG. 5 is a block diagram of an example computing device that may perform one or more of the operations described herein, in accordance with one or more embodiments.

FIG. 6 illustrates an example of a receptacle with sensors, used for recycling, which may be connected to a user device over a network.

FIG. 7 illustrates an example method for redeeming value and gathering data from one or more objects.

FIG. 8 illustrates an example network environment associated with a digital recycling platform.

FIG. 9 illustrates an example computer system.

### DESCRIPTION OF EXAMPLE EMBODIMENTS

Traditionally, a user may gather various potentially recyclable objects (e.g., aluminum cans, plastic or glass bottles, etc.). Once collected, the user must bring these collected objects to a recycling center to exchange the objects for money. Such a process is cumbersome because it requires a user to take the collected objects to a designed location and lacks additional features such as automatically providing a running total of how much a user has collected, providing signaling for a remote service to pick up collected objects, or providing flexibility for users to collaborate together to pool collected objects.

There is a need for a processing device that helps users identify and organize potentially recyclable objects. The processing device may signal to a remote system, when the user is ready to have these objects collected and provide a location to pick up these objects. The processing device may provide information to the remote system such as the total weight of collected objects, for the remote system to confirm total redemption amount against a physical measurable quantity. The processing device may receive confirmation (e.g., from the remote system) that the objects have been collected. The processing device may perform signaling with the remote system to receive credits (e.g., monetary credits) according to the total redemption value of the collected objects. These credits may be electronically stored in an account of the user. The processing device may perform various operations that improve the efficiency and experience for collecting and redeeming recyclable objects.

Aspects described may be implemented by processing logic of one or more computing devices. Processing logic may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. Processing logic may perform server-side operations of a recommendation service or client-side operations of selecting and performing a software update, or both. When an operation is said to be performed automatically in the present disclosure, the operation may be performed by processing logic without input, interaction, or approval of a user.

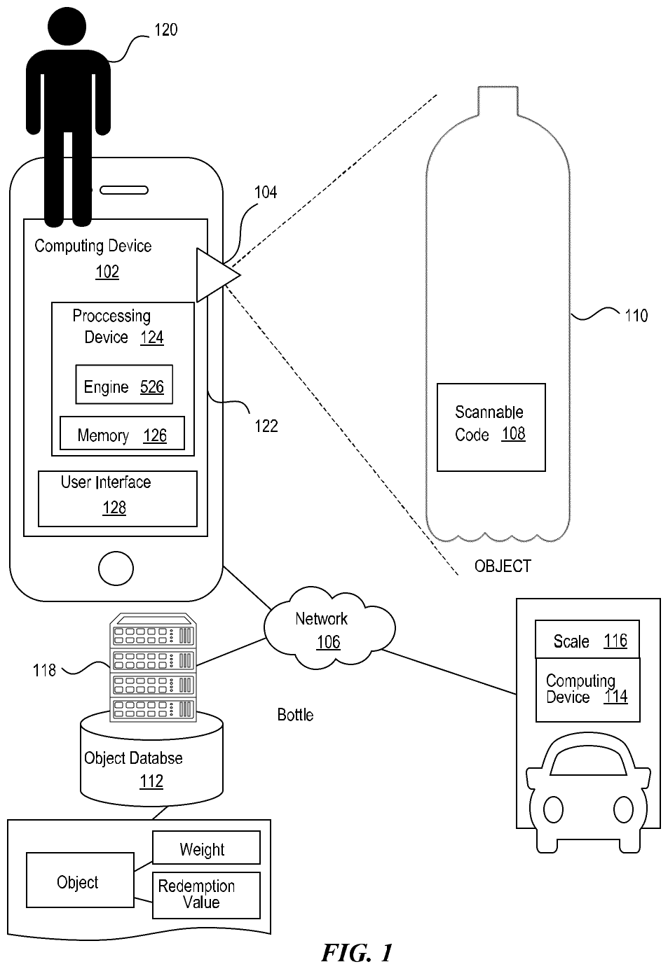

FIG. 1 shows a block diagram of an example computing device 102 that may support collection and redemption of recyclable objects, according to one or more embodiments. Computing device 102 includes a processing device 124 and a memory 126. Processing device 124 may include processing logic, for example, one or more processors and other electronic hardware that execute computer instructions (e.g., computer applications). Memory 126 may include volatile memory devices (e.g., random access memory (RAM)), non-volatile memory devices (e.g., flash memory) and/or other types of memory devices. Computing device 102 may be a mobile phone, a tablet, a laptop computer, a desktop computer, etc.

Processing device 124 of computing device 102 includes an object scanning and redeeming engine 526. The object scanning and redeeming engine 526 may comprise one or more computer applications (e.g., machine executable instructions stored on memory 126) that, when executed by processing device 124, perform operations described herein.

Computing device 102 may comprise a display 122. In some embodiments, the display may comprise a touch interface that presents the user with one or more controls. Through these controls a user may provide various inputs (e.g., button presses, typed alphanumeric values, etc.). Object scanning and redeeming engine 526 may comprise a graphical user interface 128 that includes one or more buttons, notifications, messages, navigable windows, input fields, etc. The computing device 102 may include network communication hardware and software (e.g., a wireless transmitter and receiver, LTE and/or 5G NR hardware and software components) that connects the computing device 102 to a computer network 106.

Network 106 may comprise a telecommunication network (e.g., one or more cells) that provide communication coverage through one or more known wireless communication protocols (e.g., LTE, 5G, etc.). Further, network 106 may comprise the internet, which may be include private, public, academic, business, and government computers couple over one or more computer communication protocols on a local or global scope, communicatively coupled together using a variety of electronic, wireless, and optical networking communication technologies. The network 106 may include interlinked hypertext documents and applications of the World Wide Web (WWW), electronic mail, telephony, and file sharing. Computing devices (e.g., 102, 118, 114) may use common communication protocols over digital interconnections to communicate with each other over network 106, using physically wired, optical, and wireless radio-frequency methods that may be arranged in a variety of network topologies. Computing device 102, remote server 118, and computing device 114 may be referred to as nodes of network 106.

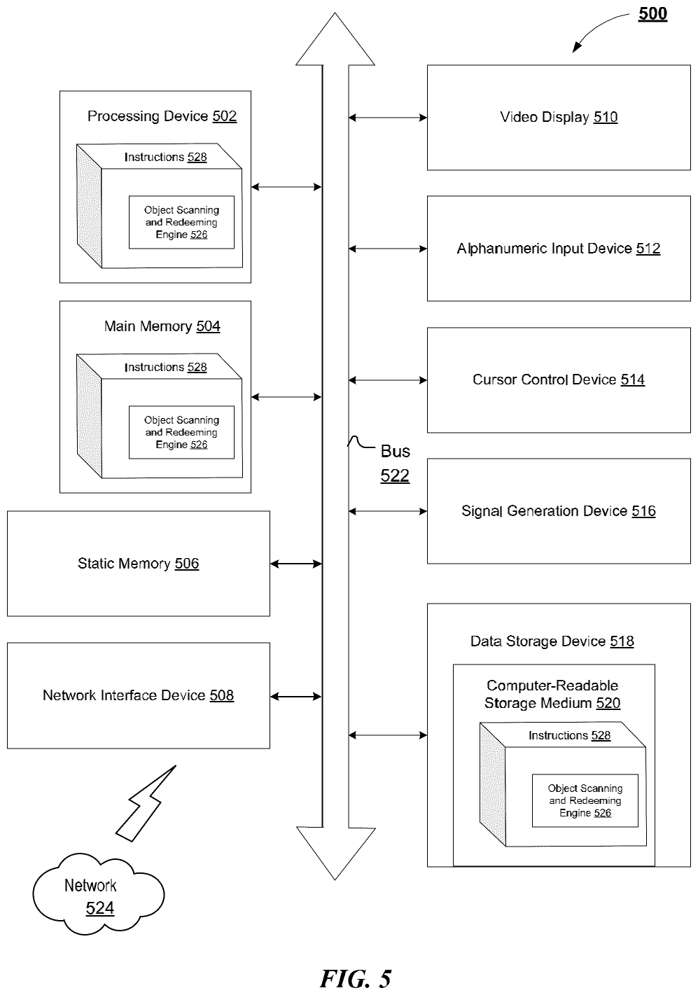

A user 120 may operate computing device 102 to initiate object scanning and redeeming engine 526 to manage recycling of one or more recyclable objects 110 as described. For example, a user 120 may provide an input through a user interface 128 to start a new recycling session. Object scanning and redeeming engine 526 (described further in FIG. 5) may authenticate that a user has access to a user account, for example, by authenticating user 120 with a username and password. Once authenticated, object scanning and redeeming engine 526 may obtain a digital token (e.g., an authentication token) which may be a unique token used for exchange and cryptography (e.g., a public or private key) that provides access to other operations described.

Once authenticated, the user 120 may provide one or more inputs for object scanning and redeeming engine 526 to initiate the session and control a sensor 104 to scan object 110.

Sensor 104 may include a general camera, or built-in camera of the computing device 102. Sensor 104 may comprise one or more image sensors such as CMOS sensors, charge coupled device (CCDs), or other light sensors. The sensor 104 may comprise a shutter and a lens, operated by processing device 124 firmware. Processing device 124 may comprise one or more algorithms such as, for example, an object recognition algorithm, a barcode recognition algorithm, a quick response (QR) code recognition algorithm. In particular embodiments, object 110 may have a scannable code 108, which may be physically fixed to a surface of the object 110. The scannable code 108 may comprise a QR code, a barcode, or other code with agreed upon convention. Object scanning and redeeming engine 526 may apply the one or more algorithms to an image generated by sensors 104 to recognize object 110 or a scannable code 108 in the image.

Processing device 124 may identify the object 110 based on the scanning, and determine, based on the identity of the device, an amount associated with the object. The amount may comprise a weight of the scanned object, and/or a redemption value of the scanned object. For example, processing device 124 may apply the one or more algorithms to identify that the object is a recyclable aluminum can. This may be done through object recognition (e.g., through using trained machine learning model), or a bar code scanning algorithm that recognizes a sequence of lines and respective thickness of each line in the bar code, or a QR code scanning algorithm that detects a unique arrangement of lines and shapes of the QR code, to identify the object. In particular embodiments, object scanning and redeeming engine 526 may determine the identity of the object as being identifiable with unique identifier ‘ABC’, or this is an aluminum can, or this is a plastic bottle, or other identification of the object 110.

The object scanning and redeeming engine 526 may communicate with a remote server 118 over network 106 to obtain one or more parameters (e.g., weight, redemption value, or both) that are associated with the identified object 110. For example, remote server 118 may serve as an interface to object database 112 that stores the one or more parameters for each object. Devices may call upon an application programming interface (API) of the remote server 118 to lookup the one or more parameters based on the identification of object 110. In some examples, object database 112 may store a plurality of different objects (e.g., 12-ounce aluminum can, 24-ounce aluminum can, 1 gallon plastic bottle, etc.) and each of their respective one or more parameters such as their weight and redemption value. The object scanning and redeeming engine 526 may obtain the weight and redemption value that corresponds to the identified object 110.

Object scanning and redeeming engine 526 may determine a total amount (e.g., a total redemption value) that is associated with a plurality of scanned objects. For example, object scanning and redeeming engine 526 may repeat the steps of scanning, identifying, and performing a lookup, to obtain the redemption value and weight of each of the plurality of objects, and determine the total amount as a sum of each of the individual redemption values, and a second sum of each of the individual weights. The total amount associated with the scanned objects in a given session may include a total redemption value, and a total weight.

Object scanning and redeeming engine 526 may send a pickup request (e.g., one or more wireless communications) to a computing device 114 over network 106. The pickup request may indicate that the plurality of scanned objects are ready for pickup. The object scanning and redeeming engine 526 may include in the pickup request, the total amount (including one or more of the total weight and total redemption value) of the objects to be picked up. In particular embodiments, computing device 102 may further provide, in the pickup request, a pickup location of the scanned objects to the computing device 114. In particular embodiments, object scanning and redeeming engine 526 may determine the pickup location (e.g., a physical address) by user input (e.g., through user interface 128). In particular embodiments, the pickup location may be determined by localizing computing device 102 such as through global positioning system (GPS) or another localization algorithm.

In particular embodiments, processing device 124 may include one or more computing devices which may be distributed as nodes on network 106 (e.g., as a server in a data center, and/or as a computing device that may be integrated on a vehicle (e.g., a truck with one or more containers to house the picked-up objects). The vehicle may comprise a scale 116 to weigh the scanned objects upon pickup. Computing device 114 may analyze the weight the scanned objects using scale 116 and verify that the weight is the same as, or within a threshold margin of error as, the total weight provided by the object scanning and redeeming engine 526 in the pickup request. In response the pickup weight being matched to the expected weight (e.g., the same or within the threshold error margin), the computing device 114 may initiate the transfer of the total amount (e.g., the total redemption value specified in the pickup request) to the user 120.

For example, computing device 114 may electronically communicate with one or more institutional accounts (e.g., a bank system or fund allocation system) over network 106 and provide confirmation that the total amount is to be transferred to a holding account (e.g., an electronic bank account of user 120). Computing device 102 may receive an indication of when pickup is successful, and when the total redemption value is transferred to the holding account of user 120. Computing device 102 may display status to user 120 on display 122.

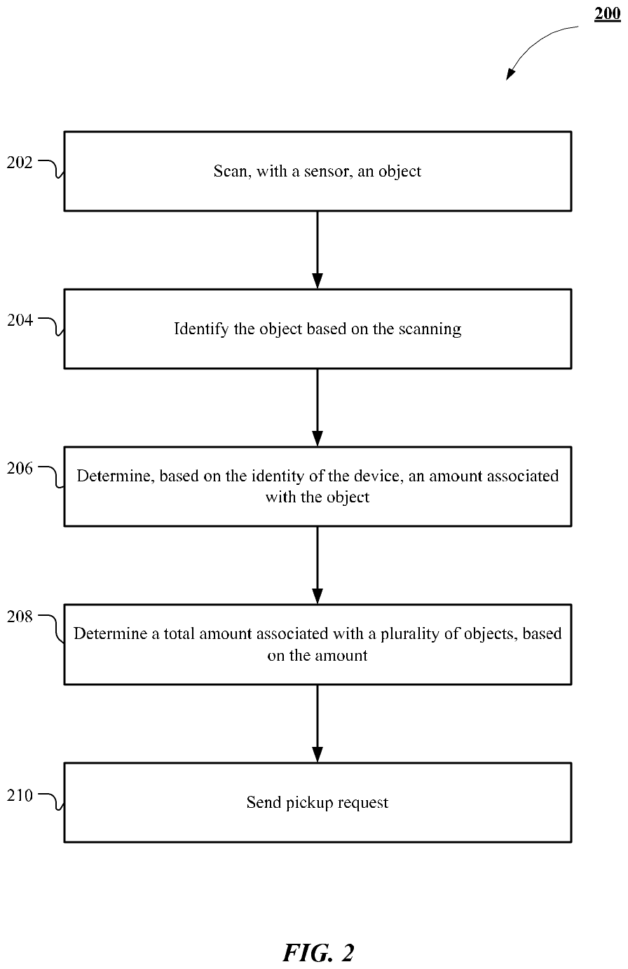

FIG. 2 illustrates a routine 200 that is performed by a mobile computing device for scanning and recycling objects, according to an embodiment. The routine may also be referred to as a method, which may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in routine 200 may be performed in an order different than presented, and that not all of the blocks in the method may be performed.

At block 202, routine 200 scans, with a sensor, an object. As described, scanning may be performed using a camera of the mobile computing device. The scanning may apply one or more algorithms to an image generated by the camera to detect and scan a barcode or a QR code.

At block 204, routine 200 identifies the object based on the scanning. For example, the routine may look up the object using the scanned barcode or QR code, to identify that the object is a 12 oz aluminum can, a 24 oz aluminum can, a 16 oz clear plastic bottle, etc. In particular embodiments, the scanning may use an object recognition algorithm to recognize and identify the object.

At block 206, routine 200 determines, based on the identity of the device, an amount associated with the object. As describe with respect to FIG. 1, routine 200 may access a database to determine the redemption value and weight that is associated with the object.

At block 208, routine 200 determines a total amount that is associated with a plurality of objects, based on the amount. For example, routine 200 may determine the total amount (e.g., a total redemption value and a total weight) by summing the current amount with the running total or previously scanned and identified objects.

At block 210, routine 200 sends a pickup request with the total amount. As described in other sections, routine 200 may send one or more wireless communications over a network to the remote system (e.g., computing device 114), indicating the total amount (including total weight and total redemption value).

In particular embodiments, routine 200 may receive confirmation from the remote system that the pickup has been performed. In particular embodiments, the remote system may weigh the plurality of objects at the pickup location specified in the pickup request and check the measured weight of the items against the total weight specified in the pickup request. If the remote system confirms that the total weight picked up matches the total expected weight (or within a threshold error margin) as indicated in the pickup request, then the remote system confirmation includes an indication that the pickup was successful.

In particular embodiments, routine 200 further comprises presenting, to a display, status of the session. For example, during scanning, routine 200 may present and update, to a display, one or more of: the total redemption value of scanned objects, a list of scanned and identified objects, a total estimated weight based on the sum weight of scanned objects. In particular embodiments, in response to sending the pickup request, routine 200 may present to the display, status showing whether a pickup vehicle has been dispatched to pick up the objects at the pickup location.

In particular embodiments, routine 200 may present to the display, the current location of the pickup vehicle (e.g., on a map). The current location of the pickup vehicle may be shown relative to the pickup location on the display. In particular embodiments, the routine 200 may present to the display, that the pickup has been performed, and whether or not the pickup was successful (e.g., if the picked-up weight of objects matched the weight provided in the pickup request).

In particular embodiments, the routine 200 may further include receiving an indication of a deposit to a user account in the amount of the total redemption value. Routine 200 may present a notification to the display, indicating that the deposit was received, and present the amount of the deposit.

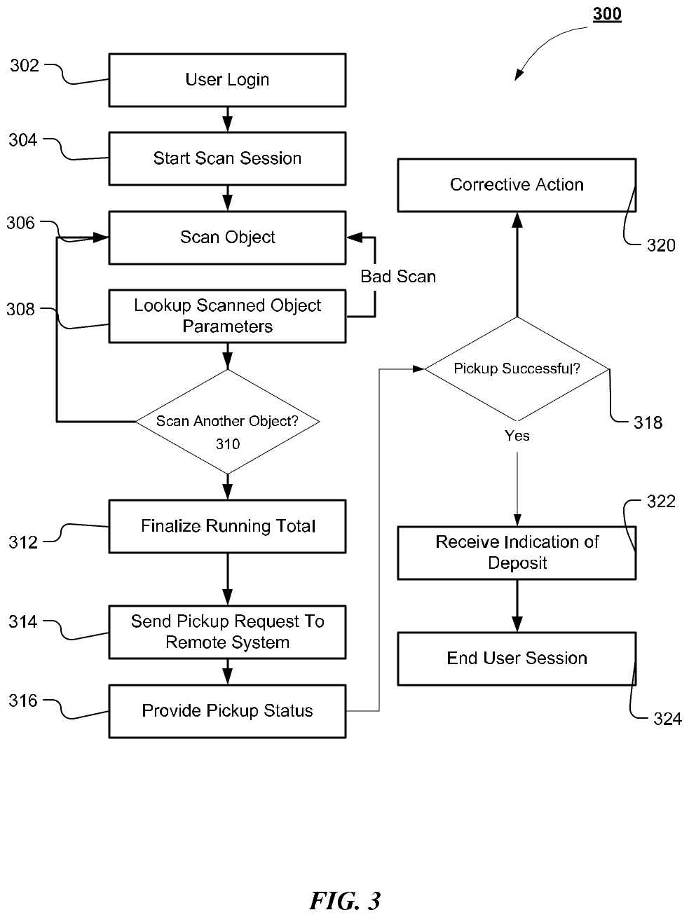

FIG. 3 illustrates a workflow 300 which may be performed by a system (e.g., one or more computing devices) for scanning and recycling objects, according to an embodiment. The routine may also be referred to as a method, which may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

As an example and not by way of limitation, the system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the system may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The system may include any suitable communication interface for any of these networks, where appropriate. Communication interface may include one or more communication interfaces, where appropriate. Although this disclosure describes and illustrates a particular communication interface, this disclosure contemplates any suitable communication interface.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in workflow 300 may be performed in an order different than presented, and that not all of the blocks in the method may be performed.

At block 302, the system may log a user into a user account. This may include presenting a user with a user interface to allow the user to input credentials. The system may verify the user credentials (e.g., a username and password, a digital cryptographic token, etc.) by performing a lookup, or through known cryptographic algorithms (e.g., key pair). The user account may be linked to a monetary account (e.g., a bank account, a digital payment platform, etc.) to view status of the monetary account, make withdrawals, or deposits.

At block 304, the system may start a scan session. The system may take user input (e.g., a press of a control) to indicate starting a new scan session. In response, the system may proceed to block 306 and prompt the user to scan an object. The system may take user input to operate a sensor when the object to be scanned is placed in the view of the sensor, to scan the object. As described, scanning may be performed with a general camera of a mobile device by applying an algorithm (e.g., a barcode detection algorithm) and obtaining a unique ID or number. If the scanning does not successfully detect a barcode, QR code, or recognize the scanned object, the system may provide a notification to the user and proceed back to block 306.

At block 308, the system may look up the scanned object parameters, which may include referencing the unique ID or number in a database to obtain the weight and redemption value for the object.

At block 310, the system may prompt the user with one or more inputs to determine whether to scan another object. The system may receive input from the user to continue to scan another object, or to proceed towards requesting pickup with the current scanned objects associated with the scanned session.

At block 312, the system may finalize the running total of all the scanned objects, for example, by summing the weight of the scanned objects, and summing the redemption value of the scanned objects. It should be noted that the order in which the total is determined may vary, and this specific order is provided for illustration purposes. For example, the system may keep a running total of the objects for a given session at block 308 each time an object is scanned.

At block 314 the system may send a pickup request to a remote system. As described, this request may include the total weight and a pickup location. It may optionally include the total redemption value.

At block 316 the system may provide status to a user of the scheduled pickup. This may include displaying, at different times, an estimated pickup time and date, when a pickup vehicle is enroute, and/or a current location of the pickup vehicle.

At block 318, the system may receive an indication of whether or not the pickup was successful. This indication may be received wirelessly over a network from the remote system. A pickup may be deemed successful by the remote system upon successfully locating and arriving at the pickup location, weighing the objects for that session, and validating the weight of the picked-up objects. Alternatively, the system may receive indication that the pickup was not successful or was delayed. In response, the system may proceed to block 320 and prompt the user if the user wishes to take corrective action or cancel the pickup request and session.

At block 322, the system may receive an indication that an amount is deposited into the user's account (e.g., a holding account, a checking or savings account, a digital payment platform account). The system may proceed to block 324 and end the user session.

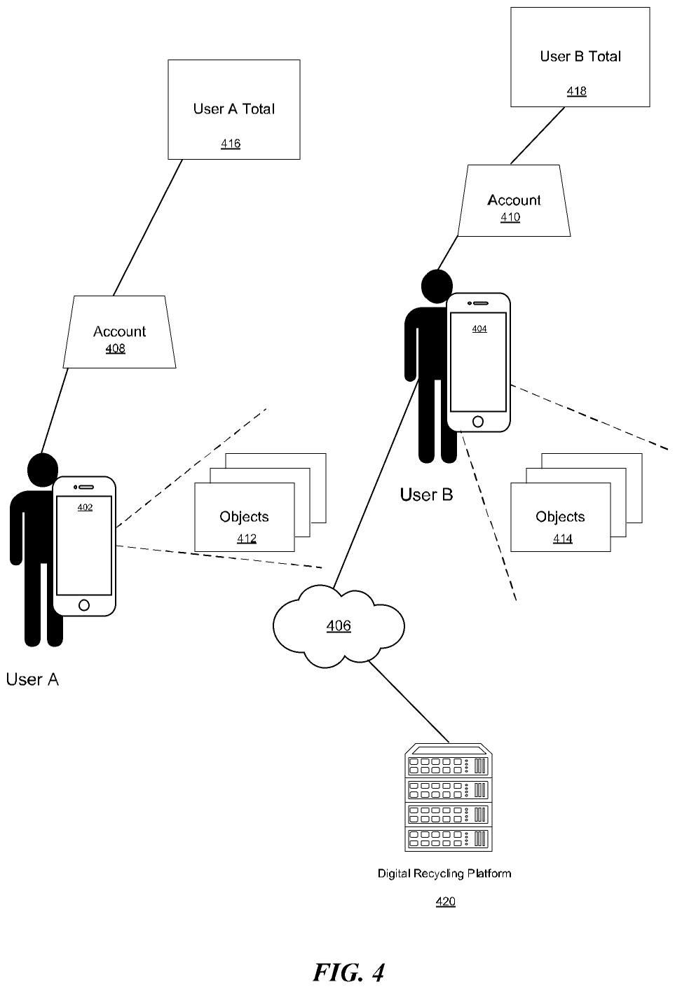

FIG. 4 illustrates an example of a digital recycling platform, according to an embodiment. The system may include a computing device that is connected to a network 406. The computing device may comprise a distributed architecture that may include a plurality of computing devices working in coordination with each other to perform operations described.

The digital recycling platform 420 may perform operations described in other sections from the perspective of a remote system. The digital recycling platform 420 may receive input from different users (e.g., user A, user B) to set up a unique account (e.g., 408, 410) for each user. Each account may be associated with a holding account, as described, to hold funds for the user. Further, digital recycling platform 420 may manage connections between different users such as, for example, between user A and user B. For example, once an account (e.g., 408, 410) is created for a given user, the digital recycling platform 420 may receive an input from the user of that account to connect and work with a second user of a different account.

For example, digital recycling platform 420 may receive a request from user A collaborate with user B. Digital recycling platform 420 may relay this request to user B. Digital recycling platform 420 may receive a confirmation from user B to collaborate with user A. User A and user B may both confirm with digital recycling platform 420 which user will receive the redemption credits for the session on which they are to collaborate. Once confirmed, digital recycling platform 420 may coordinate scanning actions between the users so that the redemption of their respective scanned objects become associated with the agreed upon account.

For example, when user A starts a new scanning session, digital recycling platform 420 may message computing device 404 to cause device 404 to prompt user B to start scanning objects. User A may operate device 402 to scan objects 412. User B may operate device 404 to scan objects 414. Each device may perform the operations described with respect to FIG. 1, FIG. 2, or FIG. 3. Each device may determine their respective totals and send out a pickup request. For example, total 416 may represent the total redemption value and total weight associated with objects 412 for the collaborated session. Similarly, total 418 may represent the total redemption value and total weight associated with objects 414 for the collaborated session. When each device sends a respective pickup request, in addition to the other parameters described, the pickup request may include an indicator that the pickup request is associated with a collaboration and identify the other pickup requests that it is in collaboration with. The pickup location may be different for each pickup request in the collaboration session. In response to multiple pickup requests identifying that they are in collaboration with each other, the digital recycling platform 420 may condition successful pickup of the collaborated session by requiring successful pickup of each individual pickup.

For example, before deeming the entire collaborated session to have a successful pickup, both total 416 and total 418 are required by digital recycling platform 420 to be confirmed (e.g., the pickup weight matches the weight of the pickup request). In response to confirmation from both pickups, digital recycling platform 420 may transfer the summed total redemption value associated with the scanned objects 412 and 414 into the agreed upon account (e.g., a holding account of user A).

It should be understood that, although described with respect to two users, the digital recycling platform 420 may support collaboration between three or more users. In such a case, the platform may receive messaging from each device that confirms that each of the three or more users wish to collaborate, and receives confirmation from each user as to which account the funds are to be deposited in. This may be performed by digital recycling platform 420 prior to starting of a session. In particular embodiments, digital recycling platform 420 may allow any user to cancel the collaboration session, but may block changing of terms of a given collaboration session (e.g., no more new collaborators) once a collaboration session is started.

FIG. 5 is a block diagram of an example computing device 500 that may perform one or more of the operations described herein, in accordance with some embodiments. For example, the computing device 500 may perform operations described for scanning, recycling, and redeeming objects. Computing device 500 may serve as a mobile computing device (e.g., a mobile computing device with an image processor 604) or as a digital recycling platform 420.

Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device 502 (e.g., a general purpose processor, a PLD, etc.), a main memory 504 (e.g., synchronous dynamic random access memory (DRAM), read-only memory (ROM)), a static memory 506 (e.g., flash memory and a data storage device 518), which may communicate with each other via a bus 522.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 524. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 520 on which may be stored one or more sets of instructions 528 that may include instructions for a processing device (e.g., processing device 124), for carrying out the operations described herein, in accordance with one or more aspects of the present disclosure. Instructions 528 may also reside, completely or at least partially, within main memory 504 and/or within processing device 502 during execution thereof by computing device 500, main memory 504 and processing device 502 also constituting computer-readable media. The instructions 528 may further be transmitted or received over a network 524 via network interface device 508. The instructions 528 may contain instructions of an object scanning and redeeming engine 526 that, when executed, perform the operations and steps discussed herein.

While computer-readable storage medium 520 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

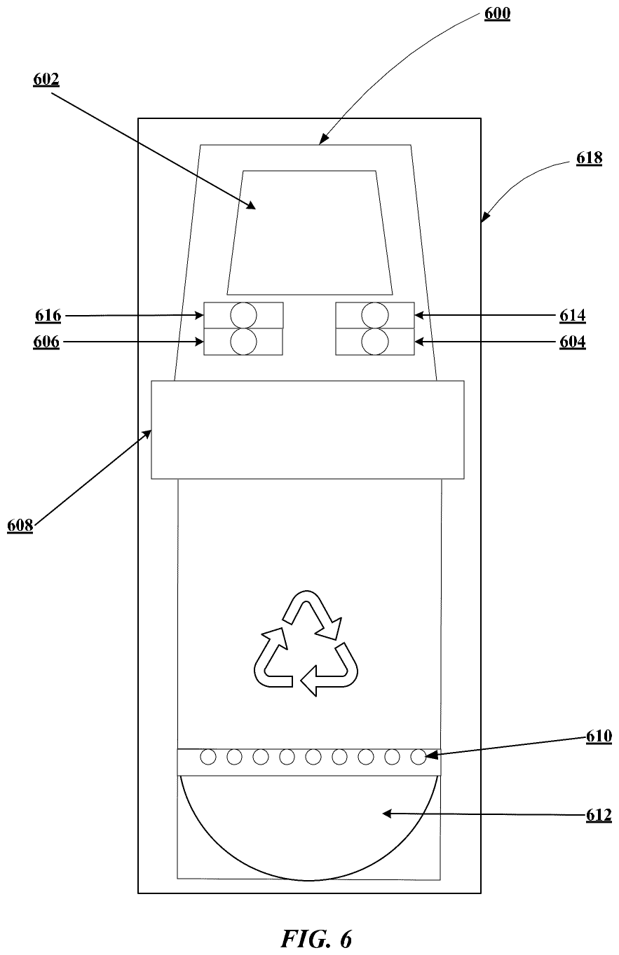

FIG. 6 illustrates an example of a receptacle 600 used for recycling, according to an embodiment. The receptacle 600 may include an image processor 604 and a weight sensor 606. The receptacle 600 may be enclosed by a metal casing 618. The metal casing 618 may include an additional image processor 614 and an additional weight sensor 616. The additional image processor 614 and the additional weight sensor 616 may be utilized in conjunction with the image processor 604 and the weight sensor 606 of the receptacle 600 to optimize the processing accuracy of objects 110. The objects may be input into the receptacle 600 via an entryway 602 of the metal casing 618. The receptacle 600 may be connected to a computing device 102 over a network 106 and used for processing objects 110 during recycling routines 200. The receptacle 600 may contain a liquid collection tray 612 which may be further equipped with a liquid strainer level 610 for draining liquid into the liquid collection tray 612. The receptacle 600 may be further equipped with a lid 608 which may include a locking mechanism.

In particular embodiments, the receptacle 600 may connect to a computing device 102 over a network 106 prior to commencing a recycling routine 200. The receptacle 600 may process objects 110 after a user 120 places them into the entryway 602. The objects 110 may be processed one or more times by one or more image processors 604 (and/or additional image processors 614) and by one or more weight sensors 606 (and/or additional weight sensors 616) and data metrics may be communicated to a computing device 102. Based on the data metrics, one or more recommendations may be provided to a computing device 102. As an example, and not by way of limitation, the receptacle 600 may communicate data metrics via an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the receptacle 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network 106 or a combination of two or more of these. The receptacle 600 may include any suitable communication interface for any of these networks, where appropriate. Communication interface may include one or more communication interfaces, where appropriate. Although this disclosure describes and illustrates a particular communication interface, this disclosure contemplates any suitable communication interface.

In particular embodiments, the receptacle 600 may be paired with a computing device 102 used by one or more users 120 prior to commencing a recycling routine 200. The receptacle 600 may process objects 110 after a user 120 places them into the entryway 602. The objects may be processed one or more times by a weight sensor 606 and an image processor 604 and data metrics may be communicated to a computing device 102. Based on the data metrics, one or more recommendations may be provided to a computing device 102. There are some cases where a scannable code 108 may not be present on the object 110, therefore, the weight sensor 606, the liquid collection tray 612, and its liquid strainer level 610 may allow the receptacle 600 and its system to register the object 110 accurately. For example, a user 120 may begin a recycling routine 200 by placing an object 110 into the entryway 602 of the receptacle 600. As an object 110 travels down further into the receptacle 600, the scannable code 108 of the object 110 may be processed by both an image processor 604 and a weight sensor 606. The image processor 604 may then use the imaging (e.g., barcode, quick-response code, etc. . . . ) information to determine what kind of object 110 was processed by utilizing manufacturer information which may be retrieved over a network. If the manufacturer information cannot be retrieved, the weight sensor may determine the true weight of the one or more objects 110 during the routine 200, and may add the newly identified object 110 into a database by communicating the information over a network 106 to a computing device 102.

In particular embodiments, the receptacle 600, metal casing 618, weight sensors 606, additional weight sensors 616, image processors 604, and additional image processors 614 may be modular, wherein they may be swapped out with additional sensors as appropriate. For example, a weight sensor 606 may be swapped out and replaced by replacement weight sensors 606 or other sensors. In addition, image processors 604 may be swapped out and replaced by replacement image processors 604 or other sensors.

In particular embodiments, the data metrics retrieved from the receptacle 600, weight sensor 606 and image processor 604 may be uploaded to a social media platform. For example, a count of 100 sprite cans may be a milestone, and hence, uploaded to a user profile over a network, and shared with other users on the social media platform.

In particular embodiments, the receptacle 600, weight sensor 606 and image processor 604 may be physically attached to a truck. For example, a user 120 may begin a recycling routine 200 by placing an object 110 into the entryway 602 of the receptacle 600. As an object 110 travels down further into the receptacle 600, the scannable code 108 of the object 110 may be processed by both an image processor 604 and a weight sensor 606. Once the routine 200 has ended, the truck may enclose the receptacle 600, and may then transfer the objects 110 to an appropriate recycling center.

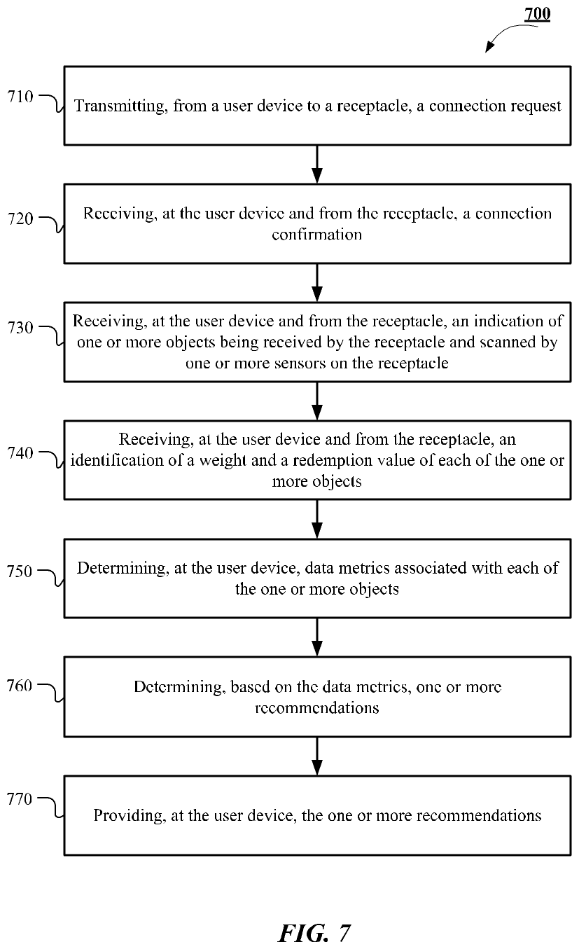

FIG. 7 illustrates an example method 700 for redeeming value and gathering data from one or more objects. The method may begin at step 710, by transmitting, from a user device to a receptacle, a connection request. At step 720, the method may include receiving, at the user device and from the receptacle, a connection confirmation. At step 730, the method may include receiving, at the user device and from the receptacle, an indication of one or more objects being received by the receptacle and scanned by one or more sensors on the receptacle. At step 740, the method may include receiving, at the user device and from the receptacle, an identification of a weight and a redemption value of each of the one or more objects. At step 750, the method may include determining, at the user device, data metrics associated with each of the one or more objects. At step 760, the method may include determining, based on the data metrics, one or more recommendations. At step 770, the method may include providing, at the user device, the one or more recommendations. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for redeeming value and gathering data from one or more objects including the particular steps of the method of FIG. 7, this disclosure contemplates any suitable method for redeeming value and gathering data from one or more objects including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

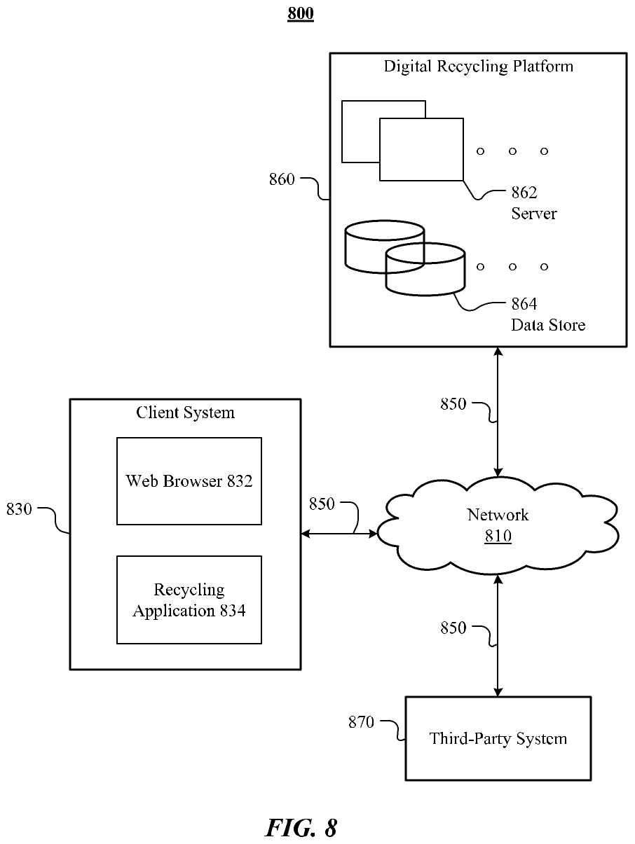

FIG. 8 illustrates an example network environment 800 associated with a digital recycling platform 860. Network environment 800 includes a client system 830, a digital recycling platform 860, and a third-party system 870 connected to each other by a network 810. Although FIG. 8 illustrates a particular arrangement of client system 830, digital recycling platform 860, third-party system 870, and network 810, this disclosure contemplates any suitable arrangement of client system 830, digital recycling platform 860, third-party system 870, and network 810. As an example and not by way of limitation, two or more of client system 830, digital recycling platform 860, and third-party system 870 may be connected to each other directly, bypassing network 810. As another example, two or more of client system 830, digital recycling platform 860, and third-party system 870 may be physically or logically co-located with each other in whole or in part. Moreover, although FIG. 8 illustrates a particular number of client systems 830, digital recycling platforms 860, third-party systems 870, and networks 810, this disclosure contemplates any suitable number of client systems 830, digital recycling platforms 860, third-party systems 870, and networks 810. As an example and not by way of limitation, network environment 800 may include multiple client systems 830, digital recycling platforms 860, third-party systems 870, and networks 810.

This disclosure contemplates any suitable network 810. As an example and not by way of limitation, one or more portions of network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 may connect client system 830, digital recycling platform 860, and third-party system 870 to communication network 810 or to each other. This disclosure contemplates any suitable links 850. In particular embodiments, one or more links 850 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 850 each may include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 850, or a combination of two or more such links 850. Links 850 need not necessarily be the same throughout network environment 800. One or more first links 850 may differ in one or more respects from one or more second links 850.

In particular embodiments, client system 830 may be an electronic computing device 102 including hardware, software, or embedded logic components or a combination of two or more such components and capable of carrying out the appropriate functionalities implemented or supported by client system 830. As an example and not by way of limitation, a client system 830 may include a computing device 102 such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 830. A client system 830 may enable a user 120 at client system 830 to access network 810. A client system 830 may enable its user 120 to communicate with other users 120 at other client systems 830.

In particular embodiments, client system 830 may include a web browser 832, recycling application 834, and may have one or more add-ons, plug-ins, or other extensions. A user 120 at client system 830 may enter a Uniform Resource Locator (URL) or other address directing the web browser 832 to a particular server (such as server 862, or a server associated with a third-party system 870), and the web browser 832 may generate a Hyper Text Transfer Protocol (HTTP) request and communicate the HTTP request to server. The server may accept the HTTP request and communicate to client system 830 one or more Hyper Text Markup Language (HTML) files responsive to the HTTP request. Client system 830 may render a webpage based on the HTML files from the server for presentation to the user 120. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, digital recycling platform 860 may gather data metrics about recycled objects 110. The digital recycling platform 860 may collect data on bottles and cans and then may utilize an algorithm to make recommendations to a user based on the objects the user processed via digital recycling platform 860. Recommendations may include suggestions about improving a user's 120 diet, including but not limited to, discount offers on various recyclable objects 110 available at grocery stores. The data metrics may be observed as a trend over time to make more personalized recommendations. Recommendations may also include prompting a user to take a specified action, such as, to redeem a reward. Rewards may be in the form of a redemption value, which includes a monetary, cash value, and/or it may take the form of credits, including but not limited to, store credits, ride-share credits, and stadium and event credits. Digital recycling platform 860 may be a network-addressable computing system that can host an online social network. Digital recycling platform 860 may generate, store, receive, and send social-networking data, such as, for example, user-profile data, concept-profile data, social-graph information, or other suitable data related to the online social network. Digital recycling platform 860 may be accessed by the other components of network environment 800 either directly or via network 810. As an example, and not by way of limitation, client system 830 may access digital recycling platform 860 using a web browser 832, or a native recycling application 834 associated with digital recycling platform 860 (e.g., a mobile application, a messaging application, another suitable application, or any combination thereof) either directly or via network 810. In particular embodiments, digital recycling platform 860 may include one or more servers 862. Each server 862 may be a unitary server or a distributed server spanning multiple computers or multiple datacenters. Servers 862 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 862 may include hardware, software, or embedded logic components or a combination of two or more such components for carrying out the appropriate functionalities implemented or supported by server 862. In particular embodiments, digital recycling platform 860 may include one or more data stores 864. Data stores 864 may be used to store various types of information. In particular embodiments, the information stored in data stores 864 may be organized according to specific data structures. In particular embodiments, each data store 864 may be a relational, columnar, correlation, or other suitable database. Although this disclosure describes or illustrates particular types of databases, this disclosure contemplates any suitable types of databases. Particular embodiments may provide interfaces that enable a client system 830, a digital recycling platform 860, or a third-party system 870 to manage, retrieve, modify, add, or delete, the information stored in data store 864.

In particular embodiments, digital recycling platform 860 may store one or more social graphs in one or more data stores 864. In particular embodiments, a social graph may include multiple nodes—which may include multiple user nodes (each corresponding to a particular user) or multiple concept nodes (each corresponding to a particular concept)—and multiple edges connecting the nodes. Digital recycling platform 860 may provide users 120 of the online social network the ability to communicate and interact with other users 120. In particular embodiments, users may join the online social network via digital recycling platform 860 and then add connections (e.g., relationships) to a number of other users 120 of digital recycling platform 860 to whom they want to be connected. Herein, the term “friend” may refer to any other user 120 of digital recycling platform 860 with whom a user 120 has formed a connection, association, or relationship via digital recycling platform 860.

In particular embodiments, digital recycling platform 860 may provide users 120 with the ability to take actions on various types of items or objects, supported by digital recycling platform 860. As an example and not by way of limitation, the items and objects may include groups or social networks to which users 120 of digital recycling platform 860 may belong, events or calendar entries in which a user 120 might be interested, computer-based applications that a user may use, transactions that allow users 120 to buy or sell items via the service, interactions with advertisements that a user 120 may perform, or other suitable items or objects. A user 120 may interact with anything that is capable of being represented in digital recycling platform 860 or by an external system of third-party system 870, which is separate from digital recycling platform 860 and coupled to digital recycling platform 860 via a network 810.

In particular embodiments, digital recycling platform 860 may be capable of linking a variety of entities. As an example and not by way of limitation, digital recycling platform 860 may enable users 120 to interact with each other as well as receive content from third-party systems 870 or other entities, or to allow users 120 to interact with these entities through an application programming interfaces (API) or other communication channels. As an example and not by way of limitation, a user may receive content from a third-party system such as advertisements and unique offers for the user to redeem, based off the user's recycling trends.

In particular embodiments, a third-party system 870 may include one or more types of servers, one or more data stores, one or more interfaces, including but not limited to APIs, one or more web services, one or more content sources, one or more networks, or any other suitable components, e.g., that servers may communicate with. A third-party system 870 may be operated by a different entity from an entity operating digital recycling platform 860. In particular embodiments, however, digital recycling platform 860 and third-party systems 870 may operate in conjunction with each other to provide social-networking services to users 120 of digital recycling platform 860 or third-party systems 870. In this sense, digital recycling platform 860 may provide a platform, or backbone, which other systems, such as third-party systems 870, may use to provide social-networking services and functionality to users 120 across the Internet.

In particular embodiments, a third-party system 870 may include a third-party content object provider. A third-party content object provider may include one or more sources of content objects, which may be communicated to a client system 830. As another example and not by way of limitation, content objects may include incentive content objects, such as coupons, discount tickets, gift certificates, or other suitable incentive objects.

In particular embodiments, digital recycling platform 860 also includes user-generated content objects, which may enhance a user's 120 interactions with digital recycling platform 860. User-generated content may include anything a user 120 can add, upload, send, or “post” to digital recycling platform 860. As an example and not by way of limitation, a user 120 communicates posts to digital recycling platform 860 from a client system 830. Posts may include data such as status updates or other textual data, location information, photos, videos, links, music or other similar data or media. Content may also be added to digital recycling platform 860 by a third-party through a “communication channel,” such as a newsfeed or stream.

In particular embodiments, the data metrics retrieved from the receptacle 600, weight sensor 606 and image processor 604 may be uploaded to a digital recycling platform 860 via network 810. For example, a count of 100 sprite cans may be a milestone, and hence, uploaded to a user profile over a network 810, and shared with other users 120 on the digital recycling platform 860.

### Systems and Methods

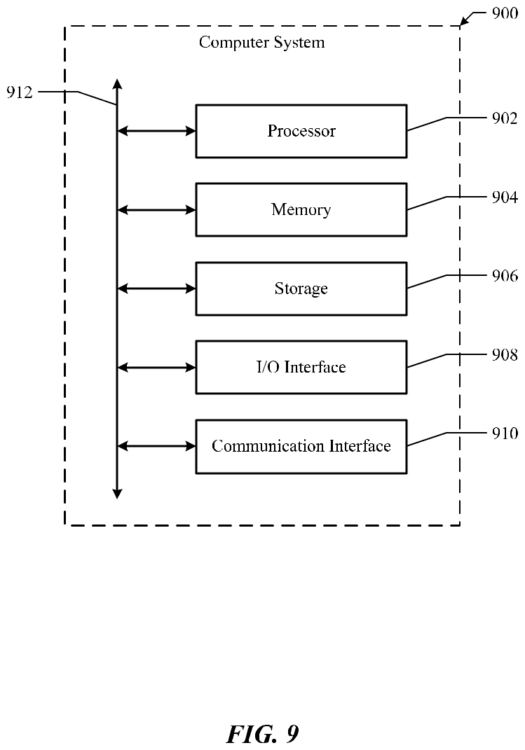

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 may be non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Recitation of Embodiments

Embodiment 1. A method, performed by a computing device, comprising: transmitting, from a user device to a receptacle, a connection request; receiving, at the user device and from the receptacle, a connection confirmation; receiving, at the user device and from the receptacle, an indication of one or more objects being received by the receptacle and scanned by one or more sensors on the receptacle; receiving, at the user device and from the receptacle, an identification of a weight and a redemption value of each of the one or more objects; determining, at the user device, data metrics associated with each of the one or more objects; determining, based on the data metrics, one or more recommendations; providing, at the user device, the one or more recommendations.

Embodiment 2. The method of embodiment 1, wherein the one or more recommendations comprises providing, at the user device, a recommendation to take a specified action.

Embodiment 3. The method of any one of embodiments 1-2, wherein the specified action comprises redeeming a reward.

Embodiment 4. The method of any one of embodiments 1-3, further comprising: receiving, at the user device, a second indication for collaboration with a second user device, wherein the indication for collaboration includes a request for selecting an agreed upon account to hold the redemption value.

Embodiment 5. The method of any one of embodiments 1-4, further comprising: transmitting, from the user device, a signal for a pickup request, wherein the signal for the pickup request includes a second indication that a pickup weight of the one or more objects matches the weight of the one or more objects indicated in the pickup request.

Embodiment 6. The method of any one of embodiments 1-5, further comprising: receiving, an indication that the redemption value is configured to be redeemed for one or more of cash value or credits.

Embodiment 7. The method of any one of embodiments 1-6, wherein the receptacle comprises a liquid strainer level configured to drain liquids into a liquid collection tray.

Embodiment 8. The method of any one of embodiments 1-7, wherein the one or more sensors comprise an image processor.

Embodiment 9. The method of any one of embodiments 1-8, wherein the data metrics can be used to identify trends for the one or more object.

Embodiment 10. The method of any one of embodiments 1-9, wherein the data metrics may be uploaded via a network to a social media platform.

Embodiment 11. A system comprising: a memory; and a processing device operatively coupled to the memory, the processing device configured to: transmit, from a user device to a receptacle, a connection request; receive, at the user device and from the receptacle, a connection confirmation; receive, at the user device and from the receptacle, an indication of one or more objects being scanned using one or more sensors; receive, at the user device and from the receptacle, an identification of a weight and a redemption value of each of the one or more objects; determine, at the user device, data metrics associated with each of the one or more objects; determine, based on the data metrics, one or more recommendations; provide, at the user device, the one or more recommendations.

Embodiment 12. The system of embodiment 11, wherein the one or more recommendations comprises providing, at the user device, a recommendation to take a specified action.

Embodiment 13. The system of any one of embodiments 11-12, wherein the specified action comprises redeeming a reward.

Embodiment 14. The system of any one of embodiments 11-13, wherein the processing device is further configured to: receive, at the user device, a second indication for collaboration with a second user device, wherein the indication for collaboration includes a request for selecting an agreed upon account to hold the redemption value.

Embodiment 15. The system of any one of embodiments 11-14, wherein the processing device is further configured to: transmit, from the user device, a signal for a pickup request, wherein the signal for the pickup request includes a second indication that a pickup weight of the one or more objects matches the weight of the one or more objects indicated in the pickup request.

Embodiment 16. The system of any one of embodiments 11-15, wherein the processing device is further configured to: receive, an indication that the redemption value is configured to be redeemed for one or more of cash value or credits.

Embodiment 17. The system of any one of embodiments 11-16, wherein the receptacle comprises a liquid strainer level configured to drain liquids into a liquid collection tray.

Embodiment 18. The system of any one of embodiments 11-17, wherein the one or more sensors comprise an image processor.

Embodiment 19. The system of any one of embodiments 11-18, wherein the data metrics can be used to identify trends for the one or more object.

Embodiment 20. A non-transitory computer-readable storage medium comprising instructions which, when executed, cause one or more processers to: transmit, from a user device to a receptacle, a connection request; receive, at the user device and from the receptacle, a connection confirmation; receive, at the user device and from the receptacle, an indication of one or more objects being scanned using one or more sensors; receive, at the user device and from the receptacle, an identification of a weight and a redemption value of each of the one or more objects; determine, at the user device, data metrics associated with each of the one or more objects; determine, based on the data metrics, one or more recommendations; provide, at the user device, the one or more recommendations.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, performed by a computing device, comprising:
transmitting, from a user device to a receptacle, a connection request;
receiving, at the user device and from the receptacle, a connection confirmation;
receiving, at the user device and from the receptacle, an indication of one or more objects being received by the receptacle and scanned by one or more sensors on the receptacle;
receiving, at the user device and from the receptacle, an identification of a weight and a redemption value of each of the one or more objects;
determining, at the user device, data metrics associated with each of the one or more objects;
determining, based on the data metrics, one or more recommendations; and
providing, at the user device, the one or more recommendations.

2. The method of claim 1, wherein the one or more recommendations comprises providing, at the user device, a recommendation to take a specified action.

3. The method of claim 2, wherein the specified action comprises redeeming a reward.

4. The method of claim 1, further comprising:
receiving, at the user device, a second indication for collaboration with a second user device, wherein the indication for collaboration includes a request for selecting an agreed upon account to hold the redemption value.

5. The method of claim 1, further comprising:
transmitting, from the user device, a signal for a pickup request, wherein the signal for the pickup request includes a second indication that a pickup weight of the one or more objects matches the weight of the one or more objects indicated in the pickup request.

6. The method of claim 1, further comprising:
receiving, an indication that the redemption value is configured to be redeemed for one or more of cash value or credits.

7. The method of claim 1, wherein the receptacle comprises a liquid strainer level configured to drain liquids into a liquid collection tray.

8. The method of claim 1, wherein the one or more sensors comprise an image processor.

9. The method of claim 1, wherein the data metrics can be used to identify trends for the one or more objects.

10. The method of claim 1, wherein the data metrics may be uploaded via a network to a social media platform.

11. A system comprising:
a memory; and
a processing device operatively coupled to the memory, the processing device configured to:
transmit, from a user device to a receptacle, a connection request;
receive, at the user device and from the receptacle, a connection confirmation;
receive, at the user device and from the receptacle, an indication of one or more objects being scanned using one or more sensors;
receive, at the user device and from the receptacle, an identification of a weight and a redemption value of each of the one or more objects;
determine, at the user device, data metrics associated with each of the one or more objects;
determine, based on the data metrics, one or more recommendations; and
provide, at the user device, the one or more recommendations.

12. The system of claim 11, wherein the one or more recommendations comprises providing, at the user device, a recommendation to take a specified action.

13. The system of claim 12, wherein the specified action comprises redeeming a reward.

14. The system of claim 11, wherein the processing device is further configured to:
receive, at the user device, a second indication for collaboration with a second user device, wherein the indication for collaboration includes a request for selecting an agreed upon account to hold the redemption value.

15. The system of claim 11, wherein the processing device is further configured to:
transmit, from the user device, a signal for a pickup request, wherein the signal for the pickup request includes a second indication that a pickup weight of the one or more objects matches the weight of the one or more objects indicated in the pickup request.

16. The system of claim 11, wherein the processing device is further configured to:
receive, an indication that the redemption value is configured to be redeemed for one or more of cash value or credits.

17. The system of claim 11, wherein the receptacle comprises a liquid strainer level configured to drain liquids into a liquid collection tray.

18. The system of claim 11, wherein the one or more sensors comprise an image processor.

19. The system of claim 11, wherein the data metrics can be used to identify trends for the one or more objects.

20. A non-transitory computer-readable storage medium comprising instructions which, when executed, cause one or more processers to:
transmit, from a user device to a receptacle, a connection request;
receive, at the user device and from the receptacle, a connection confirmation;
receive, at the user device and from the receptacle, an indication of one or more objects being scanned using one or more sensors;
receive, at the user device and from the receptacle, an identification of a weight and a redemption value of each of the one or more objects;
determine, at the user device, data metrics associated with each of the one or more objects;
determine, based on the data metrics, one or more recommendations; and
provide, at the user device, the one or more recommendations.
